(19) United States
(12) Patent Application Publication
(10) Pub. No.: US 2025/0065280 A1
(43) Pub. Date: Feb. 27, 2025

(54) DOMESTIC APPLIANCE FOR DISPENSING DRINKING WATER

(71) Applicant: BUSE KSW GMBH & CO. KG, Bad Hönningen (DE)

(72) Inventor: Max Taha, Nordhorn (DE)

(21) Appl. No.: 18/729,261

(22) PCT Filed: Jan. 13, 2023
(86) PCT No.: PCT/EP2023/050738

§ 371 Date: Jul. 16, 2024

(30) Foreign Application Priority Data
Jan. 18, 2022 (DE) 20 2022 100 249.5

(51) Int. Cl. B01F 23/236; B01F 23/237; B01F 23/70; B01F 35/221; B01F 101/00; C02F 1/00; C02F 1/44; C02F 1/68

(52) U.S. Cl. CPC B01F 23/2363; B01F 23/237621; B01F 23/708; B01F 35/2217; C02F 1/003; C02F 1/44; C02F 1/68; B01F 2101/1805; B01F 2101/305; C02F 2201/006; C02F 2209/40; C02F 2301/043; C02F 2303/14; C02F 2307/10; C02F 2307/12

(57) ABSTRACT

Household appliance for dispensing drinking water enriched with a gas, with an outlet through which the enriched drinking water can be tapped, a flow-through enrichment unit upstream of the outlet for enriching the drinking water with the gas, a receptacle for a container with the gas, an inlet upstream of the flow-through enrichment unit, via which the drinking water can be fed to the flow-through enrichment unit, wherein the inlet is equipped with a first filter for filtering the drinking water and the outlet is additionally equipped with a second filter for filtering the enriched drinking water.

The present invention relates to a household appliance for dispensing drinking water enriched with a gas.

In particular, the enrichment can be carbonisation, in which carbon dioxide (CO₂) is added to the water. In household appliances known for this purpose, carbonisation takes place under comparatively high pressure, i.e., the water is placed in a bottle which is then pressurised with CO₂. Irrespective of the fact that this pressurisation sometimes only partially introduces CO₂ into the water and the rest escapes, other problems can also arise.

The present invention is based on the technical problem of providing an advantageous household appliance for dispensing enriched drinking water.

This is solved with the household appliance according to claim 1. In this appliance, the enriched drinking water can be tapped at an outlet, wherein the enrichment takes place upstream of the outlet in the liquid flow, i.e., the enrichment unit is operated in a continuous flow (“continuous flow enrichment unit”). Compared to the procedure described at the beginning, in which the entire contents of the bottle are carbonated, for example, the amount of water required for immediate consumption can be provided in this way. In addition to saving CO₂ or gas, for example in view of outgassing over time, this can also be advantageous for hygiene reasons. For example, stagnant water and thus the formation of bacteria or germs can be prevented.

In this respect it is also advantageous that both the outlet through which the enriched water is tapped and an inlet upstream of the flow-through enrichment unit are each equipped with a filter. The flow-through enrichment can already reduce the volume of water inside the appliance, and the risk of germs entering the enrichment unit and therefore the drinking water can be further reduced by filtering the inlet and outlet.

The flow-through enrichment can reduce the volume available for germ formation, while filtering prevents the initialisation of germs.

Preferred embodiments are the subject matter of the entire disclosure and in particular of the dependent claims, wherein in the description of the features a distinction is not always made in detail between aspects of the device and aspects of the method or use. For example, the description of a device suitable for a particular operation can also be read to refer to a corresponding operating method or use, and vice versa.

The “household appliance” (also just “appliance”) is intended for household use, although its actual use is of course not generally limited to private households. The appliance can also be used, for example, in communal kitchens in offices and clubhouses, etc. When considering suitability for household use, the gas container, i.e., typically a CO₂ cylinder, which is arranged in the receptacle, can have an internal volume of no more than 2 litres, 1.5 litres, or 1 litre, for example, with possible lower limits of at least 0.2 litres, 0.3 litres, or 0.4 litres, for example. The receptacle and the gas container are preferably housed together with the enrichment unit and possibly other components, such as a feed pump etc. (see below in detail), i.e., accommodated in the same housing. Irrespective of these details, the gas container arranged in the receptacle is then fluidly connected to the flow-through enrichment unit, i.e., during or for enrichment, gas passes from the container into the enrichment unit and there into the water.

Overall, the appliance can therefore have a relatively compact structure and be designed as an easy-to-transport appliance whose operation only requires, for example, plugging into a conventional socket (no further supply connections etc.). In use, for example, the appliance as a whole can be placed on a surface raised above the floor, such as a kitchen worktop or a table or sideboard; no complex installation is required and the initial setup can also be carried out by a private individual, for example.

The device or its function is also described with reference to how the water is guided and treated in the device. This is generally not intended to imply that the water must also flow and be treated accordingly to fulfil the subject matter but is to be read as referring to an appropriately set up device (as well as a disclosure of the operating method/use). The “being set up” can mean, for example, that the device is equipped with corresponding fluid lines (for the water and, for example, also gas), which connect the individual components with each other, e.g., the inlet with an inlet side of the enrichment unit and its outlet side with the outlet (in each case for the water). The terms “upstream” and “downstream” also refer to the flow in these fluid lines. Furthermore, the “being set up” can also mean that the device comprises a control unit which, for example, controls a feed pump and/or a valve or valves and thus causes the described process to be carried out, for example, in response to actuation by a user.

The second filter, which the enriched drinking water passes through at the outlet, preferably has a filter membrane with a pore size of no more than 0.5 μm, further and particularly preferably no more than 0.3 μm or 0.2 μm. A micromembrane filter is preferred, i.e., the lower limit of the pore size can be 0.1 μm. The filter membrane can preferably have a sleeve shape, in particular a hollow cylindrical shape, i.e., delimit a sleeve or hollow cylinder interior and, during operation, flow through it radially to a longitudinal axis, preferably from radially outside into the interior. In general, a larger membrane surface can be realised with the sleeve shape, for example in comparison to a flat geometry (e.g., filter disc), so that even with a small pore size, the flow rate is not significantly limited during output.

With the filtering of the outlet, as a result of which, for example, all of the dispensed water passes through the second filter, in particular the filter membrane, during tapping, the appliance can be protected in particular even when no water is being dispensed. As explained at the beginning, the introduction of germs via the outlet can be prevented. In this respect, the small pore size can be advantageous. The filter membrane can preferably be made of ceramic.

According to a preferred embodiment, the second filter is part of a filter unit that is replaceable as a whole, i.e., can be removed and replaced by another filter unit of identical construction. Part of this filter unit can be, for example, the filter membrane and a housing part at which the filter unit can be gripped and handled with less risk of contamination. Preferably, the filter unit has an outlet hose through which the water is discharged downstream of the second filter. This outlet hose, which is located outside the filter and is therefore susceptible to contamination, is therefore replaced together with the filter, which is advantageous from a hygiene point of view.

The outlet hose can have a length of at least 2 cm, 4 cm, or 6 cm, for example, with possible upper limits of at most 30 cm, 25 cm, or 20 cm, for example. Irrespective of these details, the outlet hose is preferably arranged in a pipe socket installed with the appliance, preferably a pipe socket extending away from the housing as a tap. The pipe socket can have a bent or curved shape, at least in sections, which is ergonomic when tapping, for example, but can be difficult to access for cleaning. A hygienic solution is nevertheless possible by arranging the outlet hose of the filter unit, which is then replaced together with the latter (i.e., the filter unit), in the bend.

In general, the inlet can also be filtered with a filter membrane, in particular a micromembrane filter. However, the first filter is preferably provided as an activated carbon filter, in a preferred embodiment, it is part of an overall multi-stage filter cartridge. The water flows sequentially through its stages, whereby the water can also be mineralised or treated in addition to being filtered. The filter cartridge is assigned to the inlet, i.e., upstream of the enrichment unit. In addition to protecting against the introduction of germs, this arrangement can also be advantageous in terms of gas enrichment.

The filter cartridge can also include the following stage or stages, for example:
sand, in particular cleaned sand, for filtering out solids; and/or
coral material, in particular from sea corals, e.g., in granular form, for binding lime and e.g., also chlorine; and/or
minerals to mineralise the water, e.g., with magnesium and/or calcium; and/or
quartz crystals, especially natural rock crystal, e.g., for energising/vitalising.

The second filter is preferably upstream of this/these filter stage(s) and is particularly preferable the first stage of the filter cartridge. Cleaning can help to improve the subsequent gas enrichment, for example, because more free hydrogen bonds are then available. The binding of, e.g., lime by the coral material can also be advantageous in this respect, and enrichment can also be improved by prior mineralisation. Preferably, the filter cartridge has all the stages listed above, and particularly preferably these are flowed through in the order in which they are mentioned.

Preferably the inlet is formed at or in a reversibly removable and reinsertable water tank, which can, for example, have a capacity of at least 0.5 litres or 0.7 litres. In view of the design as a household appliance, the upper limits can also be, for example, a maximum of 2 litres, 1.5 litres, or 1 litre. In use, the water tank is removed for filling and then reinserted when filled. Water is preferably drained via the underside, where, for example, a self-closing valve can be arranged, which is opened mechanically or by appropriate actuation, e.g., when inserted into the appliance.

The water tank is preferably equipped with a removable lid, and a base is preferably formed at its underside. This allows the filled water tank to be set down, and it is particularly advantageous to place it in a refrigerator to cool the water. Although such storage could in principle be problematic with regard to the introduction of germs, in the present device the water undergoes gas enrichment, and thus also the upstream and downstream filtration, after storage.

In a preferred embodiment, the first filter, in particular a filter cartridge, is arranged in the water tank. In other words, the filtered inlet is located in the water tank, so any germ formation would be limited to this. The water tank is comparatively easy to remove and clean and is preferably dishwasher safe.

Preferably, the filter cartridge is reversibly removable and reinsertable in the water tank, particularly preferably inserted from above into an opening in the base. The filter cartridge can be part of a filter unit which, when inserted, extends, for example, to at least half the height, preferably at least 0.7 times the height, of the water tank, which can simplify removal and reduce handling inside the water tank and thus any possible introduction of germs. Preferably, the filter unit arranged in the water tank has a filter level upstream of the filter cartridge, preferably a stainless-steel grid, e.g., with a pore size of at most 50 μm, 20 μm, or 15 μm (with a possible lower limit of e.g., at least 5 μm).

A filter unit with an openable chamber, preferably upstream of the filter cartridge, can also be advantageous. A cleaning tablet can be inserted into the chamber, e.g., for a cleaning mode of the appliance, and/or a tablet can be added to treat the actual drinking water, e.g., a flavour tablet. Due to the arrangement upstream of the filter cartridge and thus outside the inner area protected by the filter, this is possible without hygienic restrictions for both the appliance itself and the user (unlike, for example, with flavouring at the outlet side).

According to a preferred embodiment, a bypass line is provided parallel to the path through the enrichment unit, through which water can be fed past the enrichment unit from the inlet to the outlet. If, for example, part of the water fed via the inlet is fed through the bypass line and another part of it is fed through the enrichment unit at the same time, the water resulting in the mixture can then have a medium level or degree of enrichment, for example. This allows the enrichment unit to be operated with an essentially constant flow rate, for example, or the flow rate can be set to optimise the operation of the enrichment unit.

In a preferred embodiment, the appliance is set up to dispense water in different enrichment levels in response to a corresponding user actuation. In general, a continuous selection possibility (without dedicated enrichment levels) is also conceivable, but preferably different levels are predefined (or can be predefined in a configuration mode of the control unit). One level can be, for example, maximum enriched water, in which case, for example, all the water is fed through the enrichment unit and the bypass line remains out of operation. In an intermediate enrichment level, as described in the previous paragraph, water can be fed through the enrichment unit and through the bypass line at the same time. A further stage can be still water, in which case the enrichment unit remains out of operation and all the water is fed through the bypass line.

In general, the appliance preferably has a feed pump by means of which the water is fed from the inlet, e.g., from the water tank, through the interior to the outlet. This means that, unlike a connection directly to the water pipe and thus the municipal water supply, for example, fewer or no pressure fluctuations need to be taken into account, which can enable stable operation and a compact design (no oversizing). With this in mind, the feed pump in a preferred embodiment also has a constant output, e.g., of at most 150 W, 120 W, 100 W, or 80 W (with possible lower limits of at least 40 W or 50 W). The design for a constant delivery rate can also be economically advantageous, whereby different enrichment levels can nevertheless be realised, e.g., in combination with the bypass line.

In a preferred embodiment, the enrichment unit has a flow-through chamber and, downstream of this, a mixing and calming chamber. The water flows through the flow-through chamber, e.g., essentially laminar. The gas is supplied to this water flow in the flow-through chamber, preferably at the outer circumference of the flow. In a sense, a gas jacket is created around the flowing water and is also carried along by it. The flow itself can be advantageous with regard to the gas supply, as the gas can be sucked into the flow like in a water jet pump (Venturi principle). This means that the gas does not have to be supplied at too high of an overpressure in relation to the water, for example, the gas pressure can be a maximum of 6 bar (and the water pressure can be around 5 bar, for example). The limited pressure is an advantage, especially in view of the “household appliance” application environment, e.g., from a safety point of view and also with regard to the compact design.

To supply the gas, the flow-through chamber is preferably embedded in an enrichment chamber, i.e., the flow-through chamber and the enrichment chamber form a double-walled system, so to speak. The outer wall defines the enrichment chamber, and the inner wall separates the flow-through chamber and the enrichment chamber from each other. Gas can then be introduced into the flow-through chamber via one or more openings in the inner wall, e.g., distributed around the perimeter.

No or no significant mixing needs to take place in the flow-through chamber, for this purpose, the fluid flow (of water and gas) is channelled into the mixing and calming chamber. In a preferred embodiment, a separating plate is arranged in between, in which an opening with a relatively small cross-section is provided to fluidly connect the chambers, preferably, a plurality of such openings are provided (the opening cross-sections can, for example, be in the range of several 10 μm and thus significantly smaller than the flow cross-section in the flow-through chamber). The abrupt change (jump) in diameter realised with the separating plate can lead to turbulence in the laminar flow, but in particular also to a drop in pressure. As a result, the water can even pass into the gas phase, which can, for example, enable a particularly efficient gas entry due to the free bonds. With regard to the orientation of the installed device, the openings are preferably located at the top, the water can settle or condense towards the bottom of the chamber and then be removed there.

In a preferred embodiment, the mixing and calming chamber has a volume of at most 200 ml, and further and particularly preferably at most 150 ml or 100 ml (possible lower limits can be, for example, 50 ml or 70 ml). This limits the amount of water in the appliance between two draws accordingly, see the comments at the beginning.

The flow-through chamber and/or the mixing/calming chamber, and possibly also the enrichment chamber (see above), are preferably provided as injection-moulded plastic parts. Preferably, they are moulded in several parts, as separate parts, and then assembled. Seals, for example, can be arranged between the individual parts and the individual parts can be pressed together by an outer envelope structure, such as a clamp. Preferably, however, the individual parts are joined together, in particular glued together, for example with a food-safe adhesive. Irrespective of these details, a polyamide can preferably be used as the plastic, e.g., commercially available under the trade name Grilamid. One advantage here can be the particularly low surface roughness, which in turn can prevent the build-up of germs.

If the device is set up, the enrichment unit is preferably flowed through from top to bottom, i.e., the mixing and calming chamber is arranged below the flow-through chamber, for example. The water is preferably removed from the bottom of the mixing and calming chamber, i.e., at a relatively low position in relation to the appliance as a whole. For ergonomic reasons, the outlet is preferably located in the upper half of the appliance, in particular at the top of the appliance. Accordingly, in a preferred embodiment, the enriched water is then fed upwards to the second filter via a connecting line, whereby the connecting line can have a comparatively small volume (hardly any dead volume), e.g., no more than 30 ml or 20 ml.

The invention also relates to the use of a device disclosed herein for dispensing enriched drinking water, in particular in a private household. Preferably, the water is dispensed in different enrichment levels in response to a corresponding user selection, with different levels being particularly preferably predefined, for example “still”, “medium” and “sparkling”. Regardless of the level of enrichment, the user is preferably activated via a button, i.e., the water is dispensed continuously as long as the user presses the button (and the water tank is still sufficiently full, for example). For this purpose, the appliance can be equipped with a push button, but the push button function can also be stored, for example, in conjunction with a touch display in the evaluation or control unit of the appliance.

In a preferred embodiment, the first and/or the second filter is replaced at regular intervals, see also the comments above. Preferably, they are replaced at the same intervals, which can, for example, prevent operating errors or cross-contamination. It is particularly preferable for the first and second filters to be provided as a set, e.g., in a common outer packaging. The appliance can indicate to the user when a filter needs to be replaced, e.g., via the number of remaining draughts or the remaining draught quantity (e.g., in litres). The interval between two filter changes can be based on the time or the quantity drawn, for example, or both variables can be used in combination. The information can be displayed on the appliance itself, e.g., visually via a display, or alternatively or additionally, the information can also be shown in an app linked to the specific appliance. For this purpose, the appliance can be smart, i.e., equipped with a sensor system and an interface, whereby the former can record operating data (e.g., amount of water dispensed), which is output via the latter, for example directly to a connected handheld device (tablet, smartphone, etc.) or initially via a server.

The operating data output by a smart appliance can also include, for example, gas consumption, in particular CO₂ consumption. Inline enrichment, particularly in the embodiment described above, can result in a relatively low gas consumption, which can be displayed to the user, for example in relation to the enrichment described at the beginning by pressurising a container (in which a relatively large amount of gas can be lost). The display of gas consumption can also have a positively reinforcing effect on user behaviour, for example if different enrichment levels are available, leading to a more conscious choice of the lower enrichment level.

According to a preferred embodiment, a cleaning agent is introduced into an openable chamber of a filter unit with the first filter/filter cartridge and, for example, a cleaning mode of the appliance is activated via the control unit. In particular, the cleaning agent can be a cleaning tablet, e.g., Kukident.

In the following, the invention is explained in more detail by means of an exemplary embodiment, wherein the individual features within the scope of the dependent claims can also be relevant to the invention in other combinations and no further distinction is made in detail between the different claim categories.

In detail it is shown in

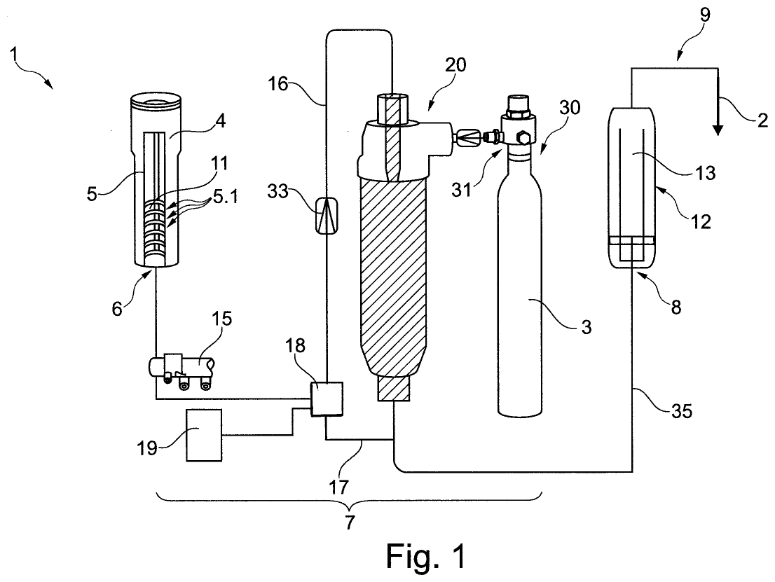

FIG. 1 a schematic overview of a device for dispensing carbonated water in a flow-through enrichment unit;

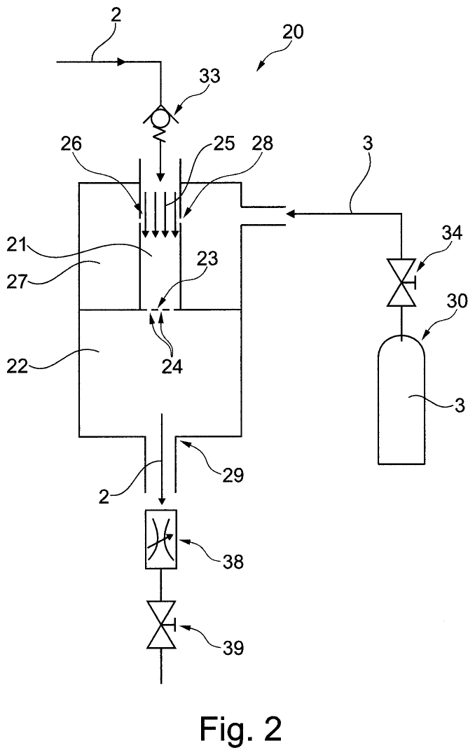

FIG. 2 a schematic detailed representation of the continuous enrichment unit of the device shown in FIG. 1;

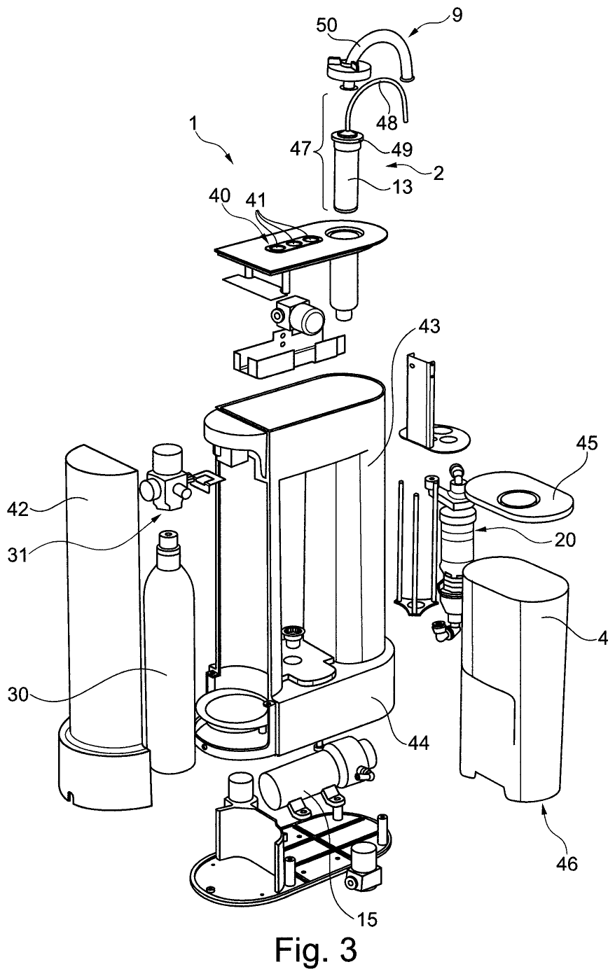

FIG. 3 the housed device with its components in an exploded view;

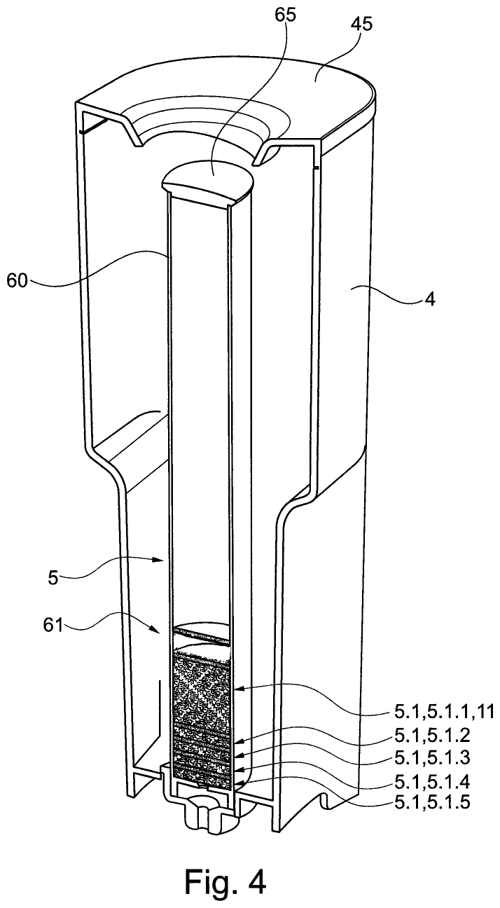

FIG. 4 a sectional side view of the water tank of the appliance with the filter cartridge inside.

FIG. 1 shows an appliance 1 for dispensing drinking water 2 that is enriched with a gas 3, in this case CO₂. The appliance 1 has a water tank 4 that can be removed for filling. A filter cartridge 5, which is discussed in more detail below, is provided in the water tank 4 and has a total of several stages 5.1. One of these stages 5.1 forms a first filter 11 and is filled with activated carbon granulate in the present case. The filter cartridge 5 with the first filter 11 is assigned to an inlet 6, i.e., the water flows through it at the transition from the water tank 4 into the interior of the appliance 7.

The appliance 1 also has a second filter 12, which is assigned to an outlet 8. The water flows through the second filter 12 upstream of a tap 9. It can prevent germs from entering the inside of the appliance 7 via the outlet 8 or tap 9, which, in conjunction with the filtering of the inlet 6, reduces the overall risk of contamination. The second filter 12 has a filter membrane 13 and is designed as a micro-membrane filter with a pore size of around 0.15 μm.

A flow-through enrichment unit 20 can be seen inside 7 the appliance, the function of which is described in further detail with reference to FIG. 2. A feed pump 15 is provided upstream of the flow-through enrichment unit 20, with which the water is conveyed from the water tank 4 to the flow-through enrichment unit 20 in response to a user actuation. In addition to a flow-through line 16, via which the water can be fed through the flow-through enrichment unit 20, there also is a bypass line 17, via which water can be fed past the flow-through enrichment unit 20. The proportional division can take place at a two-way valve 18, which is controlled by a control unit 19 of the appliance 1.

Depending on the desired level of enrichment, the proportion of water fed through the bypass line 17 and thus past the enrichment unit 20 can be larger or smaller, for example, all of the water can be fed through the bypass line 17 for the “still” variant or no water at all for the “sparkling” variant. The enriched water is taken from the bottom of the enrichment unit 20 and fed upwards via a connecting line 35. Accordingly, the second filter 12 and the tap 9 are arranged at the top of the appliance 1.

A container 30, in which the gas 3 is stored, is coupled to the enrichment unit 20. The container 30 is designed as a bottle and is inserted into a receptacle 31. In this example, the container 30 is screwed in and can be removed when the gas 3 has been used up and replaced with a filled bottle.

FIG. 2 shows the enrichment unit 20 in schematic detail. The water 2 is fed to the enrichment unit 20 via a non-return valve 33 and then initially enters a flow-through chamber 21, downstream of which a mixing and calming chamber 22 is provided. A separating plate 23 is arranged between the two chambers, through which a large number of openings 24 (micro-openings) pass. The supplied water 2 flows essentially laminar through the flow-through chamber 21, whereby the gas 3 is supplied to this flow 25 at the outer circumference 26. For this purpose, the flow-through chamber 21 is embedded in an enrichment chamber 27, whereby the two are connected to each other via openings 28.

The enrichment chamber 27 is pressurised with the gas 3 at a slightly higher pressure than the water (e.g., around one bar). This causes the gas 3 to form a jacket around the flow 25, whereby mixing takes place when it hits the separating plate 23 or enters the mixing and calming chamber 22. The previously laminar flow becomes turbulent, and the water can change into the gas phase due to the pressure drop resulting from the diameter jump. This enables a particularly efficient attachment of the water molecules to the gas, the water condensing at the bottom of the mixing and calming chamber 22 is enriched with the gas, in this case carbonized.

The water 2 is discharged via an outlet 29 at the bottom of the mixing and calming chamber 22. Via a flow rate regulator 38 and a tap valve 39, it finally reaches the second filter 12 (not shown here) and tap 9 (also not shown). The container 30 is also connected via a valve 34, which is used to adjust the gas pressure in the enrichment chamber 27.

FIG. 3 shows an exploded view of the appliance 1. The viewing direction is slightly oblique from the top rear, with the tap 9 arranged at the top front. A control panel 40 with three buttons 41, which can be used to request water with varying levels of enrichment, can also be seen at the top. The receptacle 31 is provided at the rear and the container 30 is inserted, it is then covered by a form-fit cover 42. The enrichment unit 20 is housed in a front housing part 43, while the feed pump 15 is located in a base part 44. The water tank 4 is located between the chamber with the container 30, which can be opened by removing the cover 42, and the front housing part 43 with the enrichment unit 20. It can be removed from the side, in the present illustration diagonally downwards to the right. The water tank 4 is equipped with a lid 45, which can be removed for filling and cleaning. On the underside, the water tank 4 has a base surface 46, allowing it to be placed on a flat surface and, in particular, placed in a refrigerator for cooling purposes.

The second filter 12, i.e., the filter membrane 13, is part of a filter unit 47, which also comprises an outlet hose 48 and a housing part 49, via which the outlet hose 48 is connected to the filter membrane 13. The filter unit 47 is replaced as a whole, i.e., including the outlet hose 48, which is placed in a pipe socket 50 that extends with a bend and then downwards and is part of the tap 9. Due to the curvature, the pipe socket is difficult to access for cleaning, which is why the outlet hose 48 is positioned in the pipe socket 50 (and replaced regularly).

FIG. 4 shows the water tank 4 in a sectioned oblique view. The filter cartridge 5 is provided as part of an elongated filter unit 60 and can therefore be removed without major handling inside the water tank 4. Upstream of the first filter stage 5.1, i.e., the first filter 11 (activated carbon granulate), an openable chamber 61 is provided, into which a cleaning or flavouring tablet can be placed. Preferably, a top cover 65 can be removed for this purpose, meaning that the chamber 61 is accessible without removing the filter unit 60 from the water tank 4.

Downstream of the first filter stage 5.1.1 with the activated carbon granulate, there are further filter stages 5.1, namely in this case
a second filter stage 5.1.2, which is filled with cleaned sand;
a third filter stage 5.1.3, which is filled with a sea coral granulate;
a fourth filter stage 5.1.4, which serves to supplement with natural minerals;
a fifth filter stage 5.1.5, which is filled with rose quartz.

List of reference symbols

| | |
|---|---|
| Household appliance (“appliance”) | 1 |
| Drinking water | 2 |
| Gas | 3 |
| Water tank | 4 |
| Filter cartridge | 5 |
| Several stages | 5.1 |
| First filter stage with activated carbon granulate | 5.1.1 |
| Second filter stage with cleaned sand | 5.1.2 |
| Third filter stage with sea coral granulate | 5.1.3 |
| Fourth filter stage to supplement with natural minerals | 5.1.4 |
| Fifth filter stage with rose quartz | 5.1.5 |
| Inlet | 6 |
| Device interior | 7 |
| Outlet | 8 |
| Tap | 9 |
| First filter | 11 |
| Second filter | 12 |
| Filter membrane | 13 |
| Feed pump | 15 |
| Flow-through line | 16 |
| Bypass line | 17 |
| Two-way valve | 18 |
| Control unit | 19 |
| Continuous enrichment unit | 20 |
| Flow-through chamber | 21 |
| Mixing and calming chamber | 22 |
| Separating plate | 23 |
| Openings | 24 |
| Drinking water flow | 25 |
| Outer circumference | 26 |
| Enrichment chamber | 27 |
| Openings | 28 |
| Outlet (of the mixing and calming chamber) | 29 |
| Container | 30 |
| Receptacle | 31 |
| Non-return valve | 33 |
| Valve | 34 |
| Connecting line | 35 |
| Flow rate regulator | 38 |
| Tap valve | 39 |
| Control panel | 40 |
| Buttons | 41 |
| Cover | 42 |
| Front housing part | 43 |
| Base part | 44 |
| Lid | 45 |
| Base surface | 46 |
| Filter unit | 47 |
| Outlet hose | 48 |
| Housing part | 49 |
| Pipe socket | 50 |
| Filter unit (with filter cartridge) | 60 |
| Openable chamber | 61 |
| Lid (for opening the chamber) | 65 |

1. A household appliance for dispensing drinking water enriched with a gas, the household appliance comprising:
an outlet through which the enriched drinking water can be tapped, a flow-through enrichment unit upstream of the outlet for enriching the drinking water with the gas,
a receptacle for a container with the gas,
an inlet upstream of the flow-through enrichment unit, via which the drinking water can be fed to the flow-through enrichment unit,
wherein the inlet is equipped with a first filter for filtering the drinking water and
the outlet is additionally equipped with a second filter for filtering the enriched drinking water.

2. The household appliance according to claim 1, wherein the second filter comprises a filter membrane with a porosity≤0.5 μm.

3. The household appliance according to claim 1, wherein the second filter is part of a filter unit which can be replaced as a whole, the filter unit also having an outlet hose via which the drinking water can be discharged downstream of the second filter.

4. The household appliance according to claim 3, wherein the outlet hose is arranged in a pipe socket installed with the appliance.

5. The household appliance according to claim 1, wherein the first filter is provided as a stage of an overall multi-stage filter cartridge.

6. The household appliance according to claim 1, wherein the inlet is formed on or in a reversibly removable and reinsertable water tank.

7. The household appliance according to claim 6, wherein the first filter is provided as a stage of an overall multi-stage filter cartridge and the filter cartridge is arranged in the reinsertable water tank.

8. The household appliance according to claim 1 further comprising a bypass line which connects the inlet to the outlet in parallel with the flow-through enrichment unit.

9. The household appliance according to claim 8 further comprising a control unit which is set up to feed different amounts of water proportionally through the bypass line and through the feed-through enrichment unit depending on a degree of enrichment desired by the user.

10. The household appliance according to claim 1 further comprising a feed pump, by means of which the drinking water can be fed to the flowthrough the enrichment unit from the inlet, has a constant output performance.

11. The household appliance according to claim 1, wherein the flow-through enrichment unit has a flow-through chamber and a downstream mixing and calming chamber and is configured to flow a drinking water flow through the flow-through chamber and to supply a flow of the gas to the drinking water flow, wherein a resulting fluid flow is mixed in the mixing and calming chamber.

12. The household appliance according to claim 11, in which a separating plate is arranged between the flowthrough chamber and the mixing and calming chamber, wherein an opening is provided in the separating plate, which has a smaller cross-section compared to a flow cross-section in the flow-through chamber.

13. The household appliance according to claim 11, wherein the mixing and calming chamber has a volume of at most 200 ml.

14. The household appliance according to claim 11, wherein the flow-through chamber and/or the mixing and calming chamber is a plastic injection-moulded part.

15. The household appliance according to claim 11, wherein, based on an orientation of the appliance, the flow chamber is arranged above the mixing and calming chamber and the drinking water enriched with the gas is discharged at the bottom of the mixing and calming chamber.

16. The household appliance according to claim 15, wherein the second filter is arranged in an upper half of the appliance, relative to an orientation of the appliance, and the drinking water enriched with the gas is guided upwards from the mixing and calming chamber to the second filter via a connecting line.

17. A method of using a household appliance for dispensing enriched drinking water, said method comprising the steps of:
obtaining the household appliance according to claim 1; and
dispensing enriched drinking water from said household appliance.

18. The method of using a household appliance for dispensing enriched drinking water according to claim 17 further comprising the step of exchanging the first and/or second filter at regular intervals whereby the first and second filters are provided as a set.

19. The method of using a household appliance for dispensing enriched drinking water according to claim 17 wherein the first filter is provided as a stage of an overall multi-stage filter cartridge and wherein the filter cartridge is part of a filter unit which has an openable chamber, wherein a cleaning agent is introduced into the chamber in a cleaning mode.
